(19) United States
(12) Patent Application Publication
(10) Pub. No.: US 2002/0113402 A1
(43) Pub. Date: Aug. 22, 2002

(54) Human powered land vehicle combining use of legs and arms

(76) Inventor: Greg Ochs, Kirkland, WA (US)

Correspondence Address: GREG OCHS, 11224 NE 60TH ST., KIRKLAND, WA, 98033, US

(21) Appl. No.: 10/066,998

(22) Filed: Feb. 4, 2002

Related U.S. Application Data
(60) Provisional application No. 60/266,506, filed on Feb. 5, 2001.

(51) Int. Cl. B62K 1/00

(52) U.S. Cl. 280/282

(57) ABSTRACT

A human powered wheeled land vehicle is disclosed. The vehicle may utilize two or more wheels, including at least one driving wheel and one steering wheel. The vehicle is propelled by use of at least one of two drive methods. The first drive method having at least one lever which is positioned such that the operator is able to grasp the lever and move it back and forth perpendicularly to his body in a reciprocating fashion. A drive train mechanism translates reciprocating motion of the lever into rotational motion of the driving wheel. Two levers may preferably be provided so as to allow the operator to provide alternating motion of the levers. The vehicle is steered by at least one lever that is moved by the operator in a lateral motion. A steering mechanism translates lateral motion of the lever to angular direction of the steering wheel. The second drive method having a pair of rotationally mounted crank arms that are positioned such that the operator is able to rotate the crank arms. A second drive train mechanism transfers rotational motion of the crank arms into rotational motion of the driving wheel. The operator may preferably be secured to a seat, the seat also having a back rest, while operating the vehicle.

### CROSS-REFERENCE TO RELATED APPLICATIONS

This application is entitled to the benefit of Provisional Patent Application Serial #60/266506 filed Feb. 5, 2001.

### BACKGROUND

1. Field of Invention

The present invention relates to human powered land vehicles specifically ones that can be propelled by an operator's leg(s) only, arm(s) only or legs and arms in combination using unique and novel means of power transmission.

2. Description of Prior Art

There are many technologies today designed to allow human power to motivate land vehicles. Most notably would be conventional bicycles. This technology employs leg power to rotate pedals about a crank and sprocket to drive a rear wheel. The bicycle provides an excellent means of transportation but has a drawback in that it only uses the lower body for power.

The maximum force available to turn pedals and power a bicycle is typically limited to the force generated by a rider standing on a pedal and, therefore, limited by the weight of a rider. Extending ones leg to a relative straight position and allowing gravity to turn pedals and cranks is, for the most part, the maximum force applied.

Also, bicycles and riders present a relative large frontal area. A rider's body is centered about three to four feet above the ground thus creating significant wind resistance and restricting movement of a rider and bike through the air.

A variation of the common bicycle is disclosed in U.S. Pat. No. 4,333,664 by Milton Turner issued Jun. 8, 1982. This is known in the art as a recumbent cycle. Here a rider is oriented in an upright seated position with pedals out in front. In this configuration an operator is more comfortably positioned in a back supported seat. In addition, greater force may be exerted against the pedals by pushing against a seat back. However, this design only employs lower body muscles as well.

There are other popular means of human powered vehicles that employ upper body strength. One such type of vehicle is known in the art as a hand cycle as disclosed in U.S. Pat. No. 4,109,927 by Randall L. Harper. Michael S. Lofgren made later improvements in U.S. Pat. No. 5,853,184. Although available for use by any able bodied individuals these devices have found a major market to be paraplegics and others without use of legs or lower body.

The primary mode of power transmission is through a pair of hand cranks connected to a front wheel via a conventional chain/sprocket arrangement. A major drawback of hand cycles is relatively inefficient transfer of power to the crank mechanism.

Conventional hand cycles rely on an upper body muscle group that include forearms, wrists and shoulder. Theses muscles are smaller and do not have the same strength as those employed in a pushing or chest press motion.

Hand cycles have other disadvantages. Hand cranks are typically connected to a single front wheel by means of conventional bicycle chain and sprocket arrangement. Turning the cranks drives the front wheel and propels the cycle.

Front wheel drive is less desirable in uphill climbing and loose terrain applications such as in gravel, dirt or sand. On hill climbing a rider's weight is naturally shifted toward the rear wheel thus un-weighting the front part of the cycle and decreasing traction.

The same is true on loose terrain. As power is applied and the vehicle accelerates, an operator's weight is shifted back, slightly un-weighting the front wheel.

Another disadvantage of front crank/drive configurations is the presence of mechanisms such as chains and sprockets immediately in front of a rider. Typically unguarded, these mechanisms present an opportunity to catch loose clothing or fingers and arms. Bumping against a greasy chain or sprocket leaves grease on clothing or skin.

Hand cycles are customarily configured with a single wheel in front and two wheels in back. This three-wheeled version is known in the art as a delta configuration and poses considerable problems with stability when cornering. As a rider enters into a high-speed turn the rear wheel on the inside of the corner tends to lift off the ground. Under hard cornering conditions the vehicle can easily flip over injuring rider and damaging the vehicle.

### BASIC SUMMARY AND OBJECTS OF THE INVENTION

The present invention provides an improved human powered vehicle by combining use of arm and leg power. Accordingly, several objects of the present invention will demonstrate advantages of combining both upper and lower body muscle groups to propel the vehicle. With the present invention an operator may substantially improve his or her ability to motivate this vehicle for exercise, sport or recreation.

At least one lever and generally two levers are provided where the operator of the vehicle may efficiently grasp them. In addition one set of pedal cranks is provided. The operator propels the vehicle by moving the levers back and forth in a reciprocating fashion and rotating the pedal cranks in a rotary motion. The levers and pedal cranks are disposed such that the position assumed by the operator during propulsion is one that allows optimum use of the strength of the upper and lower body muscle groups as well as allowing for efficient breathing as is required during aerobic exercise. Applying force with ones arms in a push/pull motion delivers considerably more power than rotary hand crank devices found in the prior art.

The operator is positioned, and in some cases secured, in the seat in a position so as to provide the vehicle with a low center of gravity thus providing additional stability and low wind resistance.

The vehicle is steered by means of at least one steering wheel generally disposed at the front end of the vehicle. The direction of steering is controlled by at least one lever which when moved laterally (side to side) causes the steering wheel to pivot in the corresponding direction.

The vehicle is provided with a first drivetrain that translates the reciprocating motion of the levers into rotational movement of at least one driving wheel. The vehicle is also provided with a second drivetrain that translates the rotary motion of foot operated pedal cranks into rotational movement of at least one driving wheel. By use of the levers, pedal cranks, drivetrains, and driving wheel, in cooperation with the seat and steering system of the present invention, the resulting human powered land vehicle provides a wheeled vehicle which can be powered by the motion of the arms and legs of the operator and which is much more efficient than other wheeled vehicles found in the prior art.

In view of the foregoing, it is a primary object of the present invention to provide a human powered land vehicle which may be propelled by the movement of the operator's arms, legs, upper body, lower body or torso.

Another object of the present invention is to provide a human powered land vehicle where steering, braking and gear changing mechanisms are efficiently and conveniently used by the operator's arms and hands without release of the hand grips.

Yet another object of the present invention is to provide a human powered land vehicle with improved lower body power transmission that is more convenient and safe than those previously available.

Still yet another object of the preferred embodiment is to provide a human powered land vehicle that takes full advantage of both the push and pull stroke of reciprocating levers for propelling the vehicle.

Combining advantageous upper body strength with leg power provides a superior means of propelling the vehicle described by the present invention. Benefits include increased speed, lower coefficient of drag from lower body profile, total body exercise through the use of upper and lower body muscle groups, superior handling and stability as well as seating comfort. Further objects and advantages of the present invention will become more fully apparent from a consideration of the drawings and ensuing description.

### DRAWINGS FIGURES

FIG. 1 shows an overall perspective view of the present invention.

FIG. 2 shows a perspective view of the main frame.

FIG. 3 shows a perspective view of the front axle assembly with wheels.

FIG. 3A shows a detailed view of the cross member joined to the steering tube.

FIG. 4 shows a perspective view of the steering system.

FIG. 5 shows details of the steering linkage in the first position.

FIG. 6 shows details of the steering linkage in the second position.

FIG. 7 shows a perspective view of drivetrain components.

FIG. 8 shows a detailed view of the drivetrain.

FIG. 9 shows a detailed view of second drive train components.

FIG. 10 shows a further detailed view of second drive train components.

FIG. 11 shows a perspective view of the vehicle seat.

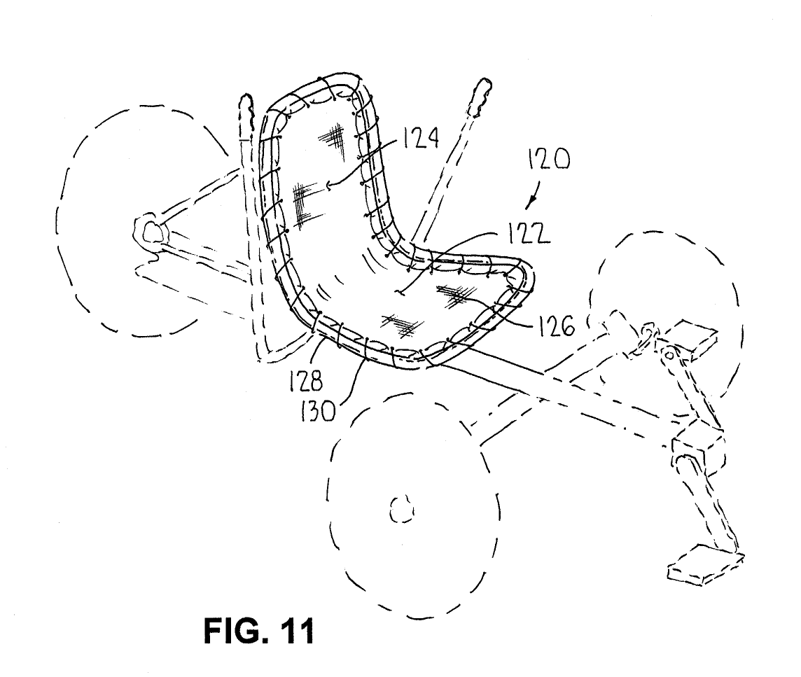

Reference Numerals in Drawings

MAIN FRAME 12

DRIVE WHEEL 14

FRONT AXLE ASSEMBLY 16

FRONT STEERING WHEELS 18 A, B

FRONT STEERING LINKAGE 20

FIRST LEVER ARM 22A

SECOND LEVER ARM 22B

FRONT PEDAL ASSEMBLY 24

DRIVE SYSTEM 26

BRAKING SYSTEM 28

GEARSHIFT SYSTEM 30

SEAT 32

CENTER BOOM 34

FIRST GEARBOX 36

SECOND GEARBOX 38

JACK SHAFT 40

SEAT TUBE 42

CHAIN STAY 44

SEAT STAY 46

PIVOT BRACKET 48

STEERING BRACKET 50

LEVER PIVOT AXLE 52

CROSS MEMBER 54

STEERING TUBE 56A, B

STEERING TUBE SHAFT 58A, B

WHEEL AXLE 60A, B

SLEEVE 62

LINKAGE ASSEMBLY 64

SWIVEL JOINT 66

CONNECTING ROD 68

MOUNTING BRACKET 70

PIVOT PIN 72

HANDLE 76A, B

BRAKE CONTROL 78

GEARSHIFT CONTROL 80

LEVER SPROCKETS 82A, B

CONTINUOUS CHAIN 84

FIRST FREEWHEEL SPROCKET 86

IDLER WHEEL 87

SECOND FREEWHEEL SPROCKET 88

CAM CLUTCH BEARING 90A, B

DERAILLEUR 92

CHAIN RING 94

CHAIN 96

SPROCKET CLUSTER 98

CALIBER BRAKE 100

INPUT SHAFT 102

GEARBOX HOUSING 104

OUTPUT SHAFT 106

PEDALS 108A, B

CRANK ARMS 110A, B

DRIVE SHAFT 112

COUPLING 114

CAM CLUTCH BEARING 116

SEAT 120

SEAT BOTTOM PORTION 122

SEAT BACK PORTION 124

FABRIC MATERIAL 126

TUBULAR FRAME 128

CORD 130

INPUT SHAFT 202

### DETAILED DESCRIPTION OF PREFERRED EMBODIMENT

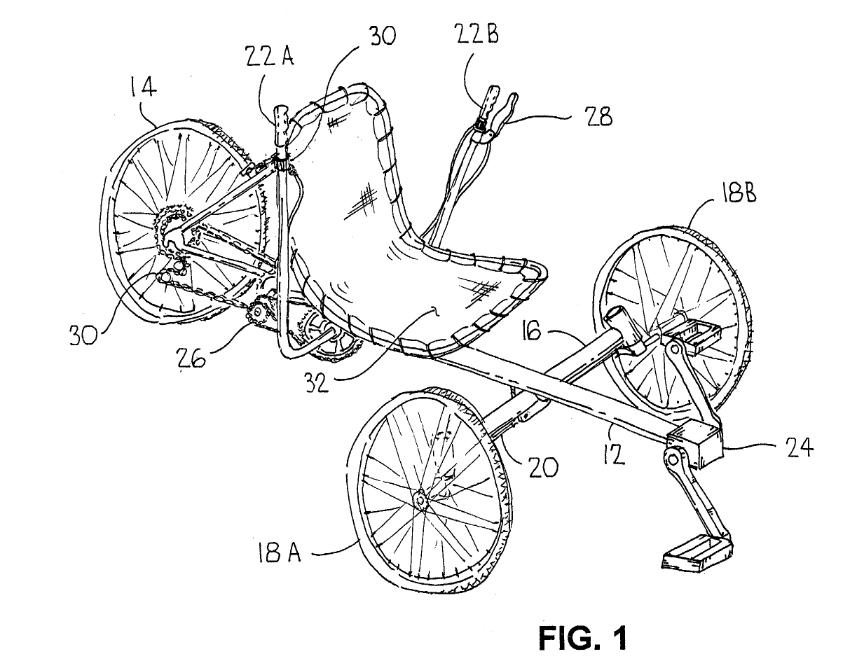

Overall View of the Present Invention—FIG. 1

The present invention is a human powered land vehicle incorporating a drive mechanism that is powered by either of two methods. One method employs the strength of the operator's upper body muscle group to operate a reciprocating drive lever and associated drivetrain to propel the vehicle. The second method employs lower body muscle groups to operate rotational pedal cranks to propel the vehicle. The fundamental advantage of the preferred embodiment is the unique ability of an operator to propel the vehicle with any combination of arms or legs.

As shown in FIG. 1, main frame 12 is intended to support an operator and the structures associated with the propulsion, steering and braking systems of the present invention. Main frame 12 is supported off the ground by front steering wheels 18A and 18B disposed at the forward end of the vehicle and one drive wheel 14 disposed at the rear end of the vehicle. Further shown is front axle assembly 16, front steering linkage 20, first lever arm 22A, second lever arm 22B, front pedal assembly 24, drive system 26, braking system 28, gearshift system 30 and seat 32.

When describing the various structures of the preferred embodiments of the present invention, many times various structures will be identically, or similarly fabricated. For example, in FIG. 1, front steering wheels 18A and 18B may be identically configured. When components of the illustrated embodiments share such similar structures, such structures will generally be similarly numbered and accompanied by different letter suffixes, such as is the case with front steering wheels 18A and 18B.

To operate the vehicle the operator is positioned within the seat 32 with torso in an upright position and legs extending out forward. Legs are positioned such that it is possible for the operator to turn front pedal assembly 24 in a rotational direction resulting in operation of the vehicle.

The operator may also grasp lever arms 22A and B positioned at either side of the torso. Pushing the levers away from the operator engages the forward stroke operation and propels the vehicle forward. Pulling the levers back toward the chest creates similar results propelling the vehicle forward. Movement of lever arms 22A and B are independent of each other and may be operated in synchronization, in alternate motion or one at a time. Steering and braking operations will be described in detail in the ensuing description.

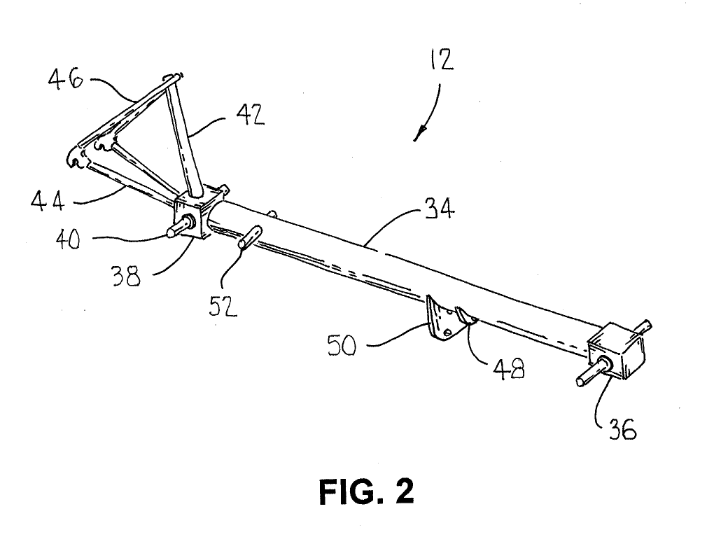

Main Frame Assembly—FIG. 2

The preferred embodiment is illustrated in further detail beginning with a main frame 12 shown in FIG. 2. Preferably, main frame components are made of welded tubular metal for strength and reduced weight. High strength chrome molly steel or 6061 aluminum tube are common materials and are well suited for high strength to weight ratio desired in human powered vehicles. Other suitable materials may include carbon fiber or other composite materials and may take on other shapes or cross sections other than tubular.

Main frame 12 is comprised of a center boom 34 with first gearbox 36 attached thereto at the forward end and second gearbox 38 attached thereto at the rearward end. Further illustrated in FIG. 2 is a supporting structure for the rear wheel namely seat tube 42, chain stay 44 and seat stay 46. Structures of the present invention will be recognized to those familiar in the art of bicycle frame construction. Forward on main frame 12 are pivot bracket 48 and steering bracket 50 used for attachment of front axle assembly 16 (not shown). Mounted toward the back of center boom 34 is lever pivot axle 52.

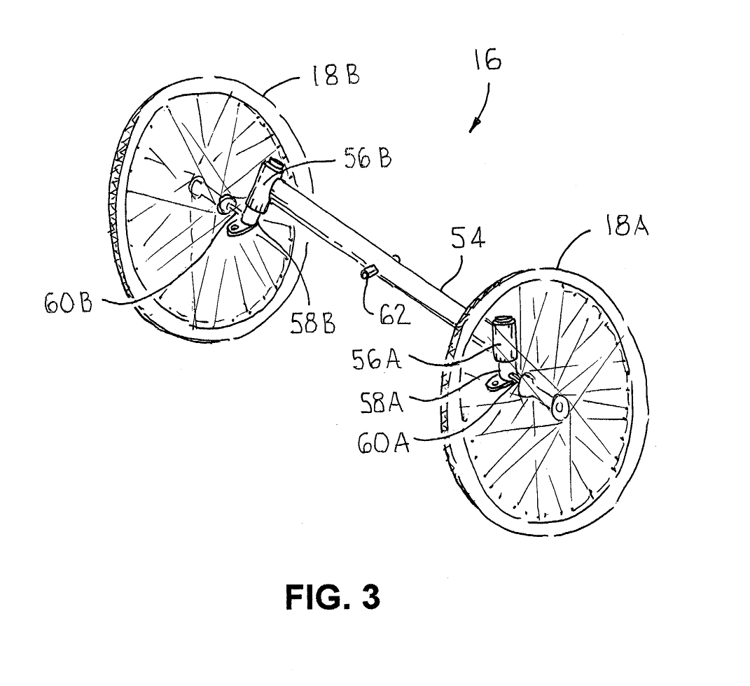

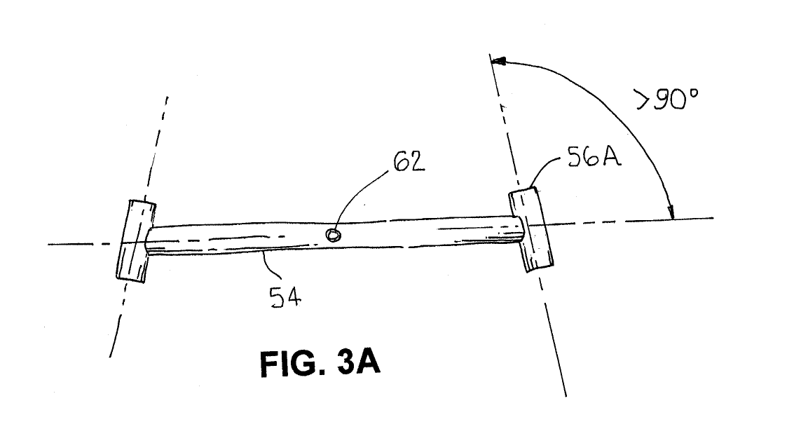

Front Axle Assembly—FIG. 3 and 3A

The preferred embodiment is further illustrated in FIG. 3 showing details of front axle assembly 16. Cross member 54 preferably of hollow metal tubing is attached to steering tubes 56A and B at an angle of greater than 90 degrees as shown in FIG. 3A. This angle is known as camber and is common on vehicles with front wheel steering such as automobiles. Returning to FIG. 3, steering tube shafts 58A and B are concentrically mounted so as to rotate axially within steering tubes 56A and B and are captured and supported by bearing structures (not shown) for smooth, low friction movement.

Attached at the lower most portion of each steering tube shaft 58A and B are wheel axles 60A and B preferably of solid steel material. Each side of front axle assembly 16 has front steerable wheels 18A and B mounted on each of the respective wheel axles 60A and B.

Sleeve 62 is located at the middle of cross member 54 and provides the means to connect front axle assembly 16 to main frame 12.

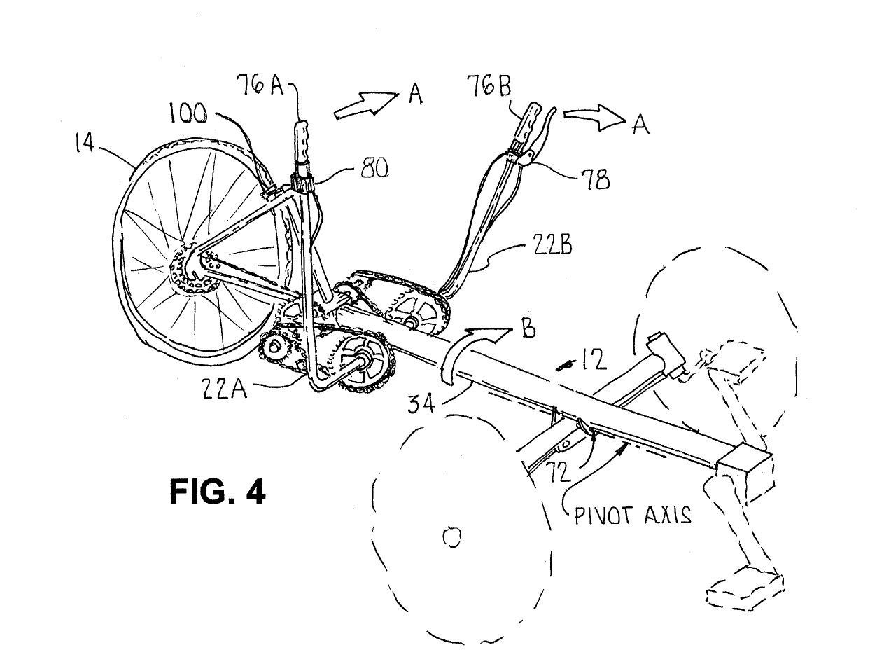

Steering System—FIGS. 4, 5 and 6

The steering system of the embodiment illustrated in FIG. 1 can best be seen in detailed views of FIGS. 4, 5 and 6. Through further detailed illustration it will be appreciated that the operator uses the same structure to propel as well as steer the vehicle. Furthermore, various other control functions, such as gear shifting and braking are also incorporated in the same structure.

In the preferred embodiment there is a first lever arm 22A mounted to the right side of main frame 12 and a second lever arm 22B mounted to the left side of main frame 12 as illustrated in FIG. 4. An operator may grab handles 76A and B of lever arms 22A and B respectively and push latterly to the side as shown with arrow A resulting in a rotation of center boom 34 about pivot pin 72 as shown with arrow B.

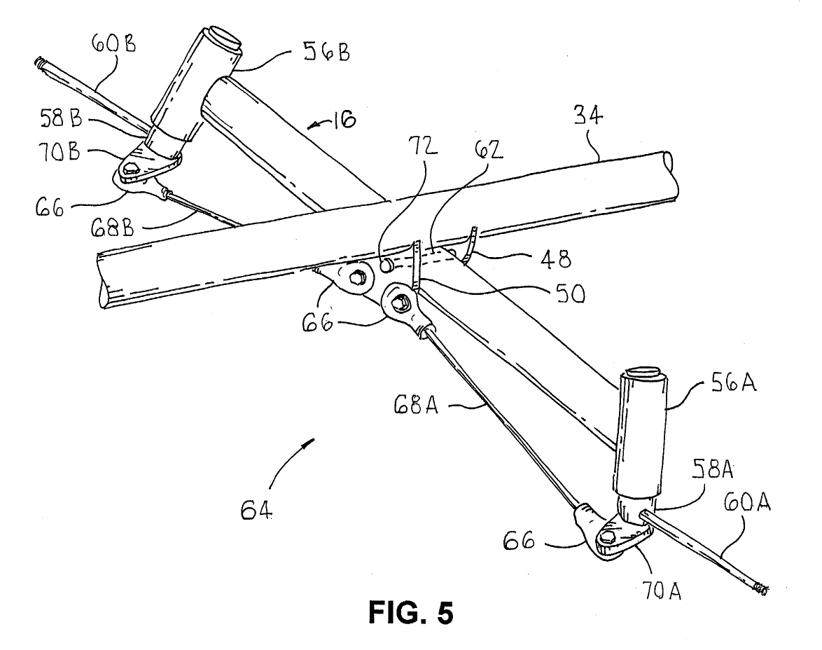

Referring now to FIG. 5, a detailed illustration of linkage assembly 64 is shown. Swivel joints 66 known in the art as rod ends are attached at both ends of connecting rods 68A and B. Mounting brackets 70A and B extend from the sides of steering tube shafts 58A and B to provide a means for attachment of connecting rod 68A and B. The opposite ends of connecting rods 68A and B are attached to center boom 34 at steering bracket 50 through swivel joints 66. Pivot pin 72 is inserted through pivot bracket 48 and steering bracket 50 capturing front axle assembly 16 through sleeve 62. Movement of main center boom is restricted to a rotational movement about pivot pin 72.

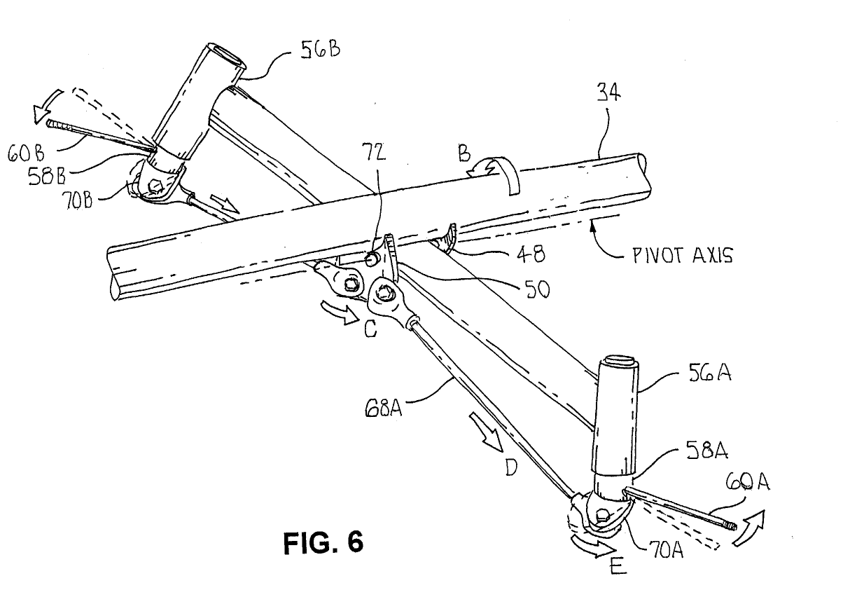

As illustrated in FIG. 6, rotation of center boom 34 shows the movement of the lower part of steering bracket 50 in a rotational motion about pivot pin 72 as shown with arrow C. Connecting rod 68A generally moves in a lateral direction as shown by arrow D resulting in rotational movement of steering tube shafts 58A and B and wheel axles 60A and B as shown with arrow E.

Referring again to FIG. 4, gearshift control 80 is preferably mounted in a convenient position such as shown on first lever arm 22A. Brake control 78 is also preferably conveniently mounted on second lever arm 22B. Furthermore, a commercially available caliper brake 100 may be readily incorporated into the present invention so as to provide a brake for drive wheel 14. As will be appreciated by those skilled in the art, alternative types of brakes, such as cantilever brakes or disk brakes may also be used on drive wheel 14 or other wheels of the present invention if additional braking capacity is desired.

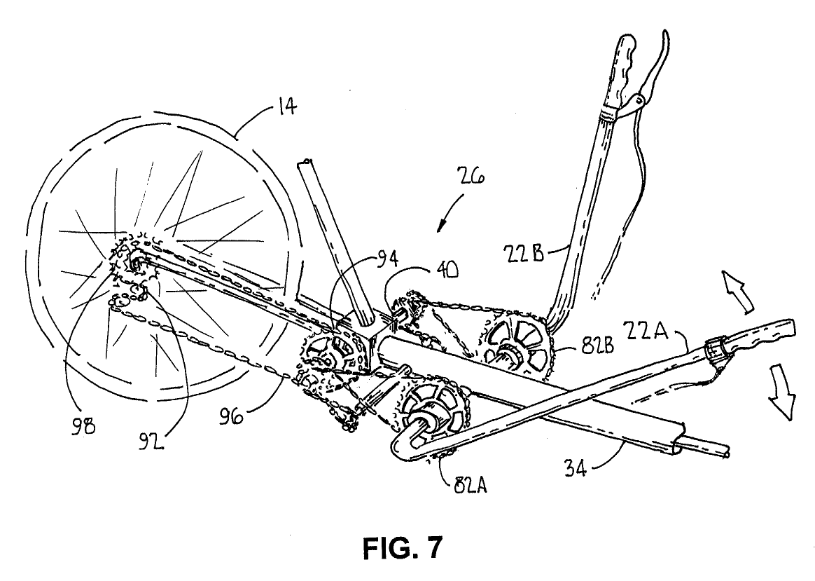

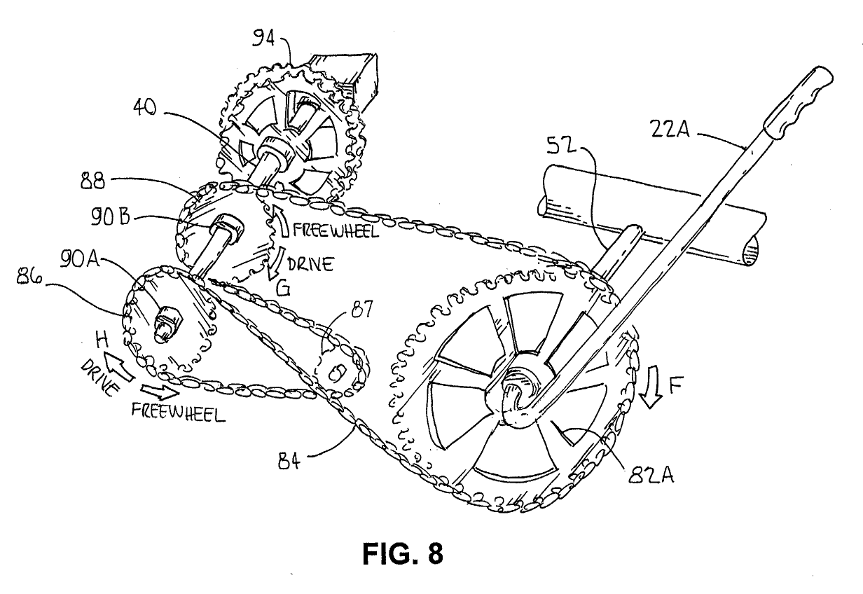

Drivetrain—FIGS. 7 and 8

Further illustration of the preferred embodiment can best be seen in FIGS. 7 and 8 showing details of drive system 26. As explained earlier, the operator moving at least one lever back and forth in the reciprocating motion propels the vehicle. The embodiment in FIG. 7 illustrates two independent levers.

Further illustration and description of the drivetrain will be restricted to one side of main frame 12 of the present invention for simplification. It will be appreciated that the present invention may include an identical structure on the opposite side of main frame 12.

As can be seen in FIG. 8, first lever arm 22A is rotationally mounted to lever pivot axle 52 and extends upwardly toward the operator. First lever sprocket 82A is rigidly connected to the lower section of first lever 22A. Translating first lever arm 22A in a back and forth motion results in a rotation of lever sprocket 82A about lever pivot axle 52.

Referring further to FIG. 8 illustrates first freewheel sprocket 86 and second freewheel sprocket 88 mounted on jack shaft 40. Jack shaft 40 is captured and supported by bearing structures (not shown) allowing axial rotation therein. Each freewheel sprocket is fitted with one way cam clutch bearings 90A and B. Cam clutch bearings in general freewheel in one rotational direction then grip or lock onto a shaft when turned in the other rotational direction.

First cam clutch bearing 90A is installed in first freewheel sprocket 86 in such orientation that clockwise rotation of first freewheel sprocket 86 grips jack shaft 40 causing clockwise rotation of jack shaft 40. Reversing rotational direction of first freewheel sprocket 86 to a counterclockwise rotation allows first cam clutch bearing 90A to freewheel on jack shaft 40. Second freewheel sprocket 88 has its respective cam clutch bearing 90B oriented in the same directional engagement as first freewheel sprocket 86 so that clockwise rotation of second freewheel sprocket 88 will cause cam clutch 90B to grip jack shaft 40 and cause clockwise rotation.

A continuous chain 84 engages a portion of first lever sprocket 82A and a portion of first freewheel sprocket 86 as further illustrated in FIG. 8. Continuous chain 84 drivingly engages the top of lever sprocket 82A and the top of second freewheel sprocket 88. Rotation of first lever sprocket 82A in a clockwise direction, as indicated by arrow F, applies tension to the interconnecting section of continuous chain 84 between first lever sprocket 82A and second freewheel sprocket 88. Second freewheel sprocket 88 is driven in a clockwise direction as indicated by arrow G. Continuous chain 84 engages the bottom of first lever sprocket 82A and extends toward and over the top of first freewheel sprocket 86 to form an S shape. Rotating first lever sprocket 82A in a counterclockwise direction applies tension to the interconnecting section of continuous chain 84. Second freewheel sprocket 88 is rotationally driven in a clockwise direction indicated by arrow H.

First lever sprocket 82A, first freewheel sprocket 86 and second freewheel sprocket 88 are preferably of a toothed sprocket design and are common power train components customarily found in mechanical drive applications.

Continuous chain 84 engages a portion of both first and second freewheel sprockets 86 and 88 and then extend toward and engage idler wheel 87. Idler wheel 87 is designed to provide tension to continuous chain 84 and, therefore, ensure adequate engagement on all sprockets.

Reversing the rotational direction of first lever sprocket 82A results in a similar reversal of both first and second freewheel sprockets 86 and 88. This produces a counter rotation of the two freewheel sprockets, 86 and 88 when first lever arm 22A is moved either forward or back.

Referring again to FIG. 7, a set of sprockets or chain rings 94 are rigidly mounted to jack shaft 40. A bicycle chain 96 is drivingly engaged on chain rings 94 and sprocket cluster 98. A derailleur 92 commonly found on conventional bicycles is used to move bicycle chain 96 from one sprocket to another of sprocket cluster 98. Sprocket cluster 98 is axially mounted to drive wheel 14 such that rotation in a clockwise direction results in rotation of drive wheel 14 propelling the vehicle. Therefore, any movement of first and second lever arms 22A and B in either a forward push or reverse pull will cause a forward rotation of rear wheel 14 and drive the vehicle forward.

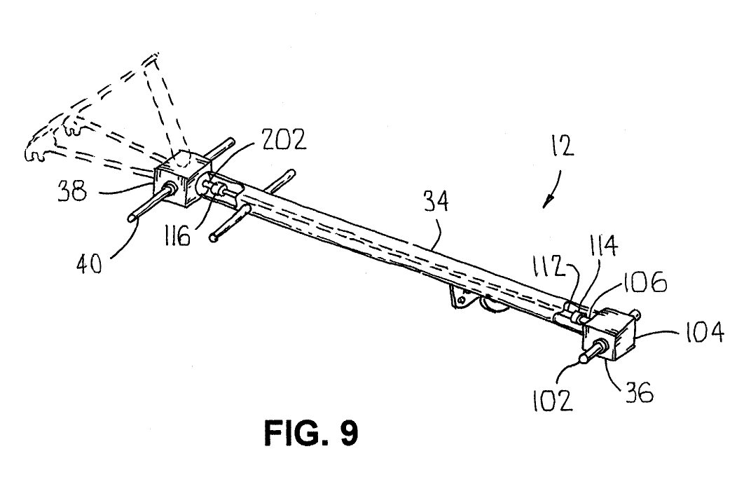

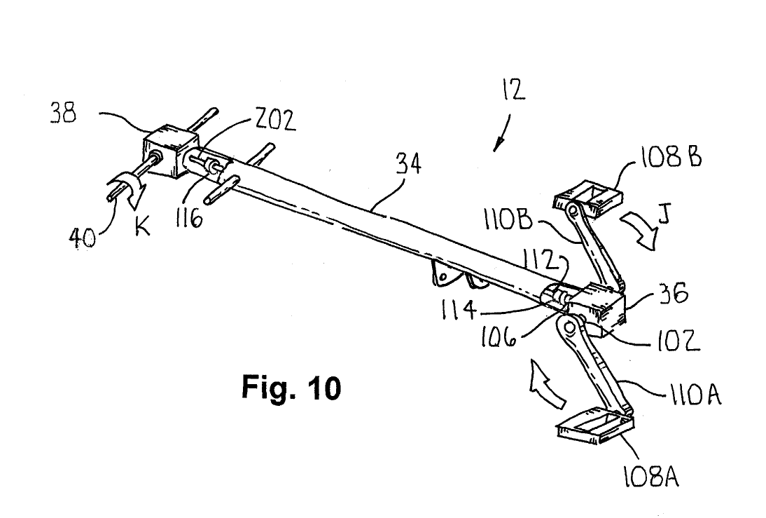

Leg Cranks—FIGS. 9 and 10

The preferred embodiment has a means for propelling the present invention with leg power as described below. Rigidly mounted to the proximal or front end of center boom 34 is a first gearbox 36 preferably of a configuration shown in FIG. 9. A single input shaft 102 extends through two opposing sides of gearbox housing 104. Input shaft 102 drivingly engages output shaft 106 through a right angle gear set (not shown). Output shaft 106 is oriented concentrically with hollow center boom 34 of main frame 12.

Located at the distal end of center boom 34 is a similar second gearbox 38. Input shaft 202 of gearbox 38 is positioned along the same concentric axis and oriented toward output shaft 106 of first gearbox 36. Drive shaft 112, preferably of hollow tubular design is drivingly engaged in first gearbox output shaft 106 at coupling 114 at the proximal end of center boom 34. Located at the distal end of center boom 34 is the second end of drive shaft 112 drivingly engaged in second gearbox 38 at cam clutch bearing 116.

Referring to FIG. 10 illustrates crank arms 110A and B attached to the protruding ends of input shaft 102. Pedals 108A and B are attached to distal ends of crank arms 110A and B respectively. Pedals and cranks are oriented in the same manner as commonly found on conventional pedal bikes. Rotating pedals 108A and B and cranks 110A and B cause a rotational movement of first gearbox output shaft 106. Drive shaft 112, in turn, rotates input shaft 202 causing rotational movement of jack shaft 40.

Pedaling in a forward or clockwise direction as indicated by arrow J results in a clockwise rotation of jack shaft 40 as indicated by arrow K. Pedaling in reverse rotation causes drive shaft 112 to freewheel through cam clutch 116 without driving jack shaft 40 thus allowing free pedaling backward.

Seat

The preferred embodiment of the present invention includes a seat 120 to support a vehicle operator consisting of a preferably metal tubular frame 128 forming a seat bottom portion 122 and a back portion 124. A woven fabric material 126 is lashed to tubular frame 128 with cord 130 creating a suspension seat somewhat conforming to the operator's body shape.

Alternative Embodiments

There are various possibilities with regard to the physical configuration of the present invention as identified below. Other drive systems may be substituted for the chain and sprocket system. These include replacing the chain with a belt. The lever sprocket and freewheel sprocket may be replaced with conventional bicycle sprockets. A reversing gearbox is another alternative that will accomplish similar drive results.

It will be appreciated that the primary intended use of the present invention is for only one individual, the operator. However, embodiments allowing the addition of a passenger and/or cargo area are contemplated within the present invention. During inclement weather or to shield rider from the sun, a canopy can be deployed to protect from rain, wind or cold.

The preferred embodiment has two wheels in front and a single driving wheel in back. Alternate configurations may include a single front wheel and two rear driving wheels. Two front and two rear wheels is another alternate embodiment along with single front and rear wheels. Alternate steering configurations would be required for these options.

Pedal drive mechanisms may include conventional chain and sprockets as found on recumbent bicycles.

One way cam clutch bearings may be substituted with ratcheting devices to achieve effectively the same result.

A molded plastic seat may be substituted for the woven fabric material defined above.

What is claimed and desired to be secured by U.S. Letters Patent is:

1. A human powered land vehicle for carrying an operator, the vehicle comprising:
support means for supporting the body of the operator;
a drive wheel disposed at the rear of the vehicle;
two steered wheel disposed at the front of the vehicle;
two lever means comprising:
first propulsion means for translating reciprocating motion of at least one arm of the operator into rotational motion of the rear drive wheel so as to propel the vehicle;
steering means for directing the front steered wheel such that the vehicle may be guided in a left, rights or straight direction, and;
two crank arm means comprising second propulsion means for translating rotational motion of at least one leg of the operator into rotational motion of the rear drive wheel so as to propel the vehicle, and;
frame means capable of carrying the support means, the drive wheel, the first and second propulsion means, the steered wheels, the steering means and the operator.

2. A human powered land vehicle as defined in claim 1 wherein the first propulsion means comprises:
first drive train means, the first drive train means comprising means for independently converting both forward and backward reciprocating motion of said lever means into unidirectional rotation motion, and;
first transmission means for converting the unidirectional rotational motion of said first drive train means into rotational motion of the drive wheel, and;
second propulsion means comprises:
second drive train means, the second drive train means comprising means for transmitting the rotational motion of the crank arm means into unidirectional rotational motion; and
second transmission means for converting the unidirectional rotational motion of the drive train means into rotational motion of the drive wheel.

3. A human powered land vehicle as defined in claim 2 wherein each of said lever arm means independently pivot about a fixed axle.

4. A human powered land vehicle as defined in claim 2 wherein first drive train means comprises:
lever sprocket means fixed to the lever arms so as to receive the rotational motion of said lever arms;
first and second freewheel sprocket means;
chain means for transmitting the rotational motion of said lever sprocket means to said first and second freewheel sprocket, and;
means for transmitting the rotational motion of said first and second freewheel sprocket to the drive wheel, and;
second drive train means comprises:
first gearbox means for converting transverse rotational motion of said crank arm means into longitudinal rotational motion.
second gearbox means for converting longitudinal rotational motion into transverse rotational motion;
power transmission means for transmitting said longitudinal rotational motion from said first gearbox means to said second gearbox means, and;
means for transmitting the rotational motion of said second gearbox means to the drive wheel.

5. A human powered land vehicle as defined in claim 4 wherein means for transmitting the rotational motion of said first and second freewheel sprocket to the drive wheel comprises;
rotational axle assembly means;
driving sprocket means affixed thereto, and;
means for transmitting rotational motion of said driving sprocket means to the drive wheel.

6. A human powered land vehicle as defined in claim 4 wherein said second gearbox means is drivingly engaged at a right angle to said rotational axle assembly means.

7. A human powered land vehicle as defined in claim 5 wherein the driving sprocket means comprises said first and said second chain ring and the means for transmitting rotational motion comprises said chain means and said first and said second sprocket attached to the drive wheel and the human powered vehicle further comprises means for changing the chain means from the first chain ring to the second chain ring and further comprises means for changing the chain means from the first sprocket to the second sprocket.

8. A human powered land vehicle as defined in claim 5 wherein the drive train means further comprises means for varying the mechanical advantage provided to the operator.

9. A human powered land vehicle as defined in claim 1 wherein the steering means comprises at least one of said lever means to be grasped by the operator, the lateral movement of said lever means directing the steered wheel.

10. A steering system for a human powered land vehicle as defined in claim 9 further comprising two steered wheels disposed in a laterally spaced relationship from one another at the front of the vehicle, both steered wheels being directed by the steering handle.

11. A human powered land vehicle as defined in claim 1 further comprising at lease one brake means associated with one of said drive wheels for stopping wheel movement.

12. A human powered land vehicle as defined in claim 1 comprising two drive wheels.

13. A human powered land vehicle as defined in claim 1 comprising a single drive wheel and a single steered wheel.

14. A propulsion system for a human powered land vehicle propelled by at least one arm or one leg of the operator, the propulsion system comprising:
a rear drive wheel rotatably mounted to a frame;
at least one steered wheel disposed at the front of the vehicle;
at least one lever means disposed so as to be moved in a reciprocating motion by at least one arm of the operator, the lever means comprising steering means for directing the front steered wheel such that the vehicle may be guided in a left, right, or straight direction;
at least one crank arm means disposed so as to be moved in a rotational motion by at least one leg of the operator;
conversion means for converting the reciprocating motion of the lever means into unidirectional rotational motion;
conversion means for converting the rotational motion of the crank arm means into unidirectional rotational motion; and
transmission means for transmitting the unidirectional motion to the rear drive wheel so as to cause rotation of the drive wheel.

15. A propulsion system for a human powered land vehicle as defined in claim 14 wherein the transmission means comprises a driving chain connected to the conversion means and a sprocket fixed to the driving wheel, the sprocket engaging the driving chain.

16. A propulsion system for a human powered land vehicle as defined in claim 15 further comprising a plurality of sprockets fixed to said drive wheel and means for moving said driving chain from one sprocket to another.
